(19) United States
(12) Patent Application Publication
(10) Pub. No.: US 2008/0215591 A1
(43) Pub. Date: Sep. 4, 2008

(54) EMAIL INTERFACE FOR WEBLOG ENTRIES

(76) Inventors: Robert Howard, Frisco, TX (US); Kenneth Robertson, Elk Grove, CA (US); Scott Watermasysk, Monroe Township, NJ (US)

Correspondence Address: ANDERSON, LEVINE & LINTEL L.L.P., 14785 PRESTON ROAD, SUITE 650, DALLAS, TX, 75254, US

(21) Appl. No.: 11/935,705

(22) Filed: Nov. 6, 2007

Related U.S. Application Data
(60) Provisional application No. 60/864,542, filed on Nov. 6, 2006.

(51) Int. Cl. G06F 17/30

(52) U.S. Cl. 707/10; 707/E17.01

(57) ABSTRACT

Posting to a blog is accomplished by sending an email to a specified address uniquely associated with the blog. When the email message is received, information on the associated blog is accessed from a database and publication data is extracted from the email message. Using information from the database, a connection is made to the blog hosting site which hosts the associated blog and the publication data is posted to the associated blog.

### CROSS-REFERENCE TO RELATED APPLICATIONS

This application claims the benefit of the filing date of copending provisional application U.S. Ser. No. 60/864,542, filed Nov. 6, 2006, entitled “EMAIL INTERFACE FOR WEBLOG ENTRIES”, which is incorporated by reference herein.

### STATEMENT OF FEDERALLY SPONSORED RESEARCH OR DEVELOPMENT

Not Applicable

### BACKGROUND OF THE INVENTION

1. Technical Field

This invention relates in general to communications and, more particularly, to a system that allows an author to post entries to a web log via email.

2. Description of the Related Art

Web logs, or more commonly “blogs”, are websites where entries are made in a journal style. Once used primarily for personal diaries, blogs are now significant sources of information in a number of fields. While early blogs were manual entries into a personal website, there are now a number of blog hosting sites which provide blogging facilities to any interested author.

A blog hosting site is generally nothing more than a site that provides an easy way to publish web accessible content (accessible through a web browser like Internet Explorer). An example of a blog hosting sites are http://weblogs.asp.net and www.blogger.com.

Publishing to a blog can be accomplished in one of two ways. First, a web interface, typically proprietary to a particular blog hosting site, is used to write content. The content for an entry typically includes a subject, a body (text), images and other files. Second, blogging software can be used which runs locally on a computer independent of the blog hosting site. Blogging software is software that must be downloaded and installed within the operating system (Windows or Macintosh for example) of the author's computer.

Blogging software, such as COMMUNITY SERVER, TYPEPAD, WORDPRESS, AND BLOGGER, typically is not proprietary to a particular blog site; rather, most blogging software uses an industry standard programming interface known as the MetaBlog API that all blog sites makes available. In general, each blog site may use a variation of the MetaBlog API.

A significant problem with blogging, especially for sites with information that changes rapidly, is that authors must either use the proprietary web interface for the blog site or download and install blogging software on their computer. The proprietary web interface is typically too complex for novice users and installing software comes with its own headaches and challenges. Most importantly, the blogging software is only available when the author is at his or her computer. Thus, if an author is at another computer and wants to post to a blog, he or she most download software to the current computer, setup the software and enter identification information. Then, if the author does not own the computer, the blogging software should be removed from the computer, along with any data remnants that might allow another user to access the blog.

Therefore, a need has arisen for a software program that allows authors to easily and conveniently publish to their blog sites.

### BRIEF SUMMARY OF THE INVENTION

In the present invention, a weblog publishing system publishes information to weblogs. The weblog publishing system includes a database for storing information related to the weblogs, circuitry for receiving an electronic message sent to an address associated with a particular weblog, wherein the electronic message contains weblog content to be added to the particular weblog, and circuitry for publishing the weblog content to the particular weblog responsive to using information from the database.

The present invention provides significant advantages over the prior art. Any device capable of sending emails can be used to post content to a weblog without the need for software other than the email program.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates a block diagram illustrating the registration process;

FIG. 2 illustrates a block diagram illustrating the publication to a blog using an email.

### DETAILED DESCRIPTION OF THE INVENTION

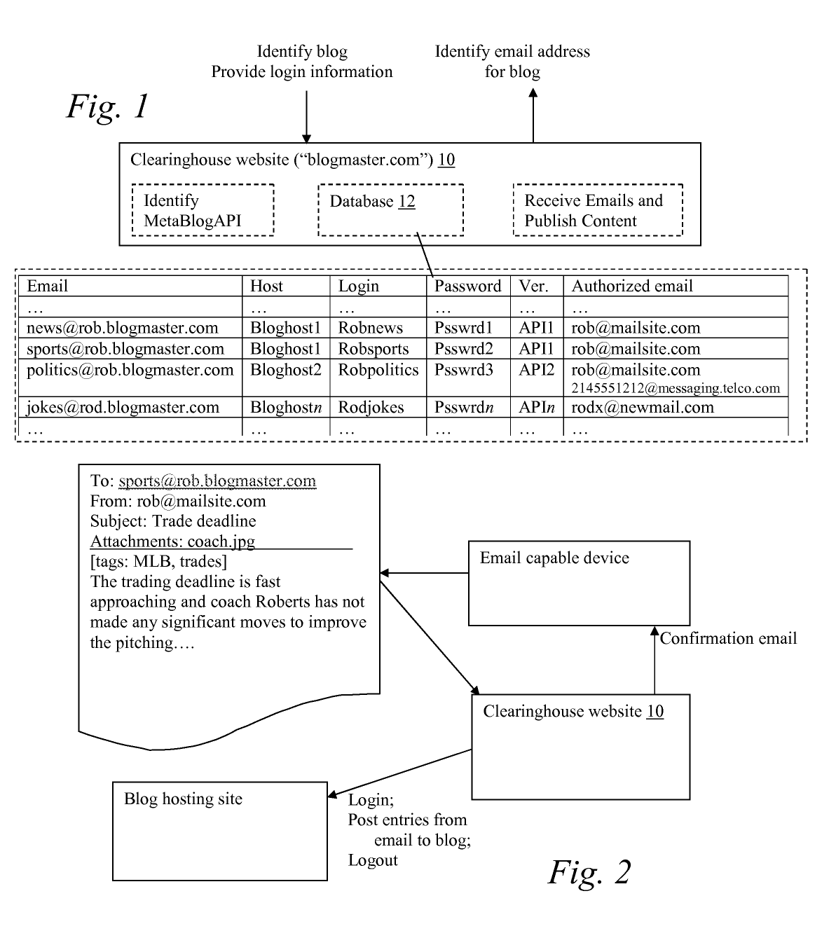

The present invention is best understood in relation to FIGS. 1-2 of the drawings, like numerals being used for like elements of the various drawings.

FIG. 1 illustrates the registration process of the invention. The author creates an account at a clearing house website (“blogmaster.com”) 10. After creating an account, the author can register one or more of the author's blogs which will use the service. For each of author's blogs, the author identifies the blog and provides information regarding login that allows the author to post entries to that blog. Software at the clearinghouse website 10 generates a unique email address to be associated with the blog; this email address is identified to the author. Software at the clearinghouse website 10 also identifies the variant of the MetaBlog API (or other blogging software) used by the blog hosting site associated with each blog and generates a entry for a database. The database associates information for each blog (including blogs for other users) with the email addresses.

For example, a user “Rob” may author three blogs: a news blog at the “bloghost1” website, a sports blog, also hosted by the “bloghost1” website, and a political commentary hosted by the “bloghost2” website. The clearinghouse website 10 might generate the following email addresses associated with the respective blogs: news@rob.blogmaster.com, sports@rob.blogmaster.com and politics@rob.blogmaster.com. The database stores the generated email address for each blog with the information associated with each blog, such as the URL of the blog hosting site, a login ID, a login password, the identified API and the author's email address (or multiple addresses), as shown in FIG. 1. Additional information, such as account information could be stored in the database 12 as well. Some or all of the information in the database is encrypted for security reasons. The database need not be on the servers of the clearinghouse website 10, so long as the information in the database can be accessed by the clearinghouse website 10.

Registration only needs to be done one time and the information can be modified for updates. Registration can be repeated for the addition or removal of a blog.

Once in possession of the generated email addresses, the author can post to the blogs simply by sending an email to the associated address, as shown in FIG. 2. The user prepares an email using any email software (such a MICRSOFT OUTLOOK, YAHOO MAIL, MICROSOFT HOTMAIL) from a computer or other electronic messaging-capable computing device, such as a mobile phone (using email or text messaging), personal digital assistant or handheld messaging device. The subject of the email indicates the heading for the blog entry. The text of the email is the text for the blog entry. Attachments, such as image files, may be added to the email, either as normal attachments or as attachments embedded in the text (as allowed by the email software). Hyperlinks may be used in the email as well, as allowed by the email software. The email is sent from one of the email addresses associated with the author (as provided during registration) to the email address associated with the blog. For example, in FIG. 2, and entry to the sports blog is being made by sending an email from rob@mailsite.com to sports@rob.blogmaster.com.

Upon receipt of an email at sports@rob.blogmaster.com, the clearinghouse site 10 looks up the database entry associated with sports@rob.blogmaster.com. Upon confirming that the “from” email address of the received email matches with an authorized email address specified in the appropriate record of the database (in this case, rob@mailsite.com) for security reasons, then the clearinghouse site:

a: reads the received email message from the author and extracts all of the data from the email format (i.e., the subject, text and attachments);

b: decrypts information from the database entry associated with the “to” address in the received email;

c: using the information from the database entry (ID and password), a connection is made to the blog hosting site using the correct MetaBlog API, as determined during registration;

d: the content of the received email is published to the blog as a blog post; and

e: an email is sent to the author confirming the posting of the information.

During publishing (step d, above), attachments in the email that are images can be displayed in the blog, while other attachments, such as .pdf files could be linked for downloading by the blog's readers. Links remain as hyperlinked text in the blog entry.

In addition, the text of the email may include embedded tags using a predetermined format, such as “[tags: blogmailr, web.2.0, fun]”, where the tags are separated by commas. The tags would be associated with the entry during the publishing step. The tags may be placed in a predetermined location in the email, such as the first line, for easy identification of the text as tags.

As noted above, multiple email addresses may be associated with a single blog. This allows a user to post content to the blog from multiple devices and multiple email programs. For example, an author may post primarily from an email programming running on his work computer and from a mobile phone, each of which will send emails using a different sender email address. While posting from third party computers, the author may use an email service with a web interface, such as from a HOTMAIL account owned by the author. In this case, the author would specify three sending email accounts as authorized email accounts. In other circumstance, a single blog may feature multiple authors, each with one or more of their own sending email addresses.

Some mobile devices, such as a mobile phone with a camera, allow sending images through an email address associated with the phone (such as “2145555555@messaging.phoneco.com”). If that address is listed as an approved sending email address in the database, images and videos can be published to the blog through the clearinghouse website 10.

The invention provides several advantages over the prior art. First, the author does not need to learn the details of a program to publish to a blog; he or she simply uses an email program with which they are already familiar. Second, any device capable of sending an email, such as a computer, mobile phone, handheld messaging device (such as the RIM BLACKBERRY), PDA (personal digital assistant), and so on, can be used to post entries to a blog, without the need for additional software.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

1. A weblog publishing system for publishing information to weblogs, comprising:
a database for storing information related to the weblogs;
circuitry for receiving an electronic message sent to an address associated with a particular weblog, wherein the electronic message contains weblog content to be added to the particular weblog;
circuitry for publishing the weblog content to the particular weblog responsive to using information from the database.

2. The weblog publishing system of claim 1 wherein the database associates each address with a particular weblog.

3. The weblog publishing system of claim 2 wherein the database associates each address with a login identifier.

4. The weblog publishing system of claim 2 wherein the database associates each address with a password.

5. The weblog publishing system of claim 2 wherein the database associates each address with a version of a weblog programming interface.

6. The weblog publishing system of claim 1 wherein the content includes text and wherein said publishing circuitry posts the text to the particular blog.

7. The weblog publishing system of claim 1 wherein the content includes images and wherein said publishing circuitry posts the images to the particular blog.

8. The weblog publishing system of claim 7 wherein the images are stored in the electronic message as an attachment.

9. The weblog publishing system of claim 1 wherein the content includes textual tags and wherein said publishing circuitry posts the textual tags to the particular blog as tags.

10. The weblog publishing system of claim 1 wherein the content includes links and wherein said publishing circuitry posts the links to the particular blog.

11. A method of posting content to a particular blog comprising the steps of:
receiving an electronic message sent to an address associated with the particular weblog, wherein the electronic message contains weblog content to be added to the particular weblog;
comparing information from the electronic message to information in a database to set up communication with the particular blog;
publishing the weblog content to the particular weblog responsive to information from the database.

12. The method of claim 11 and further comprising the step of associating each address with a particular weblog.

13. The method of claim 12 and further comprising the step of associating each address with a login identifier.

14. The method of claim 12 and further comprising the step of associating each address with a password.

15. The method of claim 12 and further comprising the step of associating each address with a version of a weblog programming interface.

16. The method of claim 11 and further comprising the step of posting text in the electronic message to the particular weblog.

17. The method of claim 11 and further comprising the step of posting images in the electronic message to the particular weblog.

18. The method of claim 17 wherein the images are stored in the electronic message as an attachment.

19. The method of claim 11 and further comprising the step of posting text tags in the electronic message to the particular weblog as tags.

20. The method of claim 11 and further comprising the step of posting links in the electronic message to the particular weblog.
